(19) United States
(12) Patent Application Publication
(10) Pub. No.: US 2017/0320013 A1
(43) Pub. Date: Nov. 9, 2017

(54) CATALYZED FILTRATION MEDIA WITH HIGH SURFACE AREA MATERIAL AND METHOD FOR MAKING THE SAME

(71) Applicant: Unifrax I LLC, Tonawanda, NY (US)

(72) Inventor: Joseph A. FERNANDO, Amherst, NY (US)

(21) Appl. No.: 15/585,863

(22) Filed: May 3, 2017

Related U.S. Application Data
(60) Provisional application No. 62/333,452, filed on May 9, 2016.

(51) Int. Cl. B01D 53/86; B01D 39/20; B01D 46/24; B01D 46/00

(52) U.S. Cl. CPC B01D 53/8628; B01D 39/2086; B01D 46/0027; B01D 46/2407; B01D 39/202; B01D 2255/915; B01D 2267/30; B01D 2267/60; B01D 2273/20; B01D 2239/10

(57) ABSTRACT

A catalytic filter with enhanced catalyst carrying capability comprising high temperature resistant inorganic fibers, at least one binder and at least one high surface area catalyst support material. Also, a method for making the catalytic filter having at least one high surface area catalyst support material.

### CROSS REFERENCE TO RELATED APPLICATIONS

The present application claims the benefit of the filing date, under 35 U.S.C. §119(e), of U.S. Provisional Application Ser. No. 62/333,452, filed May 9, 2016.

This disclosure relates to a catalytic filter comprising high surface area material and method for making the same. This disclosure more particularly relates to the improvement of the catalyst carrying capability of catalyzed filtration media by enhancing the internal, open surface area by the addition of high surface area material.

Many processes exist wherein a fluid medium (gaseous or liquid) is produced which contains material that must be separated from the fluid medium, either to prevent pollution, or to remove hazardous material.

For the purposes of this description, the catalyzed filtration media will be described in terms of its application to a hot gas candle filter, but it is to be understood that this is merely by way of example and in no way limits the catalyzed filtration media to such an application.

Hollow ceramic porous filters in a tubular (candle) shape have been used to remove particulate material from hot gases. In these hot gas filtration systems, the porous filter traps undesirable particles contained in the flow of hot gases while allowing the cleaned/filtered gas to pass through the pores of the filter into the hollow center of the candle filter. The cleaned/filtered gas travels upwards in the hollow center of the candle filter and emerges from the open end of the candle filter into an upper “clean” chamber and is then exhausted from the chamber through an exit port.

Generally, a plurality of candle filters are suspended vertically in a pressurized vessel from a tube sheet extending horizontally across the vessel. The tube sheet divides the vessel into two compartments, the lower compartment where the particulate-laden gas enters the vessel, and the upper compartment where the cleaned/filtered gas flows out of the vessel for further use or treatment, or is released into the atmosphere.

Each porous candle filter comprises a hollow cylinder closed at one end and open at the opposite end. The open end of the candle filter may have a flange which allows the candle filter to be coupled to the tube sheet of the vessel. As the particulate-laden gas passes through the porous candle filter, the particulate is trapped on the exterior surface of the candle filter and the cleaned/filtered gas flows through the pores of the candle filter into its hollow center, up and out the open end of the candle filter that is positioned in the upper compartment of the vessel, and exhausted through an exit port of the pressurized vessel.

The candle filter may comprise a flange section and a filtration section, wherein the thickness of the candle filter wall in the flange section is greater than the thickness of the candle filter wall in the filtration section. The candle filter may comprise a flange section and a filtration section, wherein the density of the candle filter wall in the flange section is greater than the density of the candle filter wall in the filtration section.

As air quality regulations become more stringent, limits on the release of nitrogen oxide (NOₓ) are becoming more restrictive. The current technology for NOₓ reduction is selective catalytic reduction (SCR). Typically the selective catalytic reduction is accomplished with honey comb catalyst support bricks. For proper operation, particulate material must be removed from the flu gas to prevent plugging or poisoning of the catalyst. With the catalytic candle filter, the catalyst imbedded in the filter converts the NOx to nitrogen and water vapor. This reaction eliminates the need for an SCR on the system, reducing capital investment and lowering operating costs. Imbedding the catalyst into the structure of the filter has the benefit of filtering particulate matter and catalytically reducing nitrogen oxides.

### BRIEF DESCRIPTION OF THE DRAWINGS

FIG. 1 is a perspective view of one illustrative embodiment of the candle filter.

FIG. 2 is a cross-sectional view of the candle filter shown in FIG. 1.

FIG. 3 is a side view, partially in cross section, of a pressurized vessel containing a plurality of the candle filters shown in FIGS. 1 and 2.

FIG. 4A is a cross-sectional view of one illustrative embodiment of the candle filter having an enhanced surface area layer adjacent the exterior surface of the filter.

FIG. 4B is a cross-sectional view of one illustrative embodiment of the candle filter wherein the at least one high surface area material is distributed across the thickness of the filter wall.

FIG. 4C is a cross-sectional view of one illustrative embodiment of the candle filter having an enhanced surface area layer adjacent the interior surface of the filter.

This disclosure describes embodiments for achieving a catalytic filter which is able to withstand the high temperatures encountered in hot gas filtration and has an enhanced catalyst carrying capability as compared to prior art catalytic filters. The high surface area material provides more binding area/sites for the catalyst material, resulting in an increase in catalyst binding efficiency and ultimately greater catalytic activity. The increased surface area permits a decreased amount of catalyst to be used, in the form of a thin catalyst layer, while still achieving sufficient catalytic activity. A monolayer of catalyst on a very large surface area provides superior catalytic activity. The high surface area material allows for more catalyst to be bound to the material and/or permits higher catalytic efficiency due to the higher surface area.

The catalytic filter may comprise a hollow cylindrical tube having a wall with an inner surface and an outer surface comprising high temperature resistant inorganic fibers, at least one binder, at least one catalyst material and at least one high surface area material.

The at least one high surface area material may be distributed across the thickness of the filter wall, in some embodiments the at least one high surface area material is substantially uniformly distributed across the thickness of the filter wall. In certain embodiments, the high surface area material is present at or near the inner and/or outer surface of the candle filter. In certain embodiments, the high surface area material is present in a separate layer adjacent to the inner and/or outer surface of the filter to form an enhanced surface area layer. The enhanced surface area layer may comprise a separate and distinct layer from the filter or may take the form of an integrated layer having a gradient composition across the thickness of the filter wall.

The candle filter may be obtained by a process of vacuum casting in a mould, a slurry containing high temperature resistant inorganic fibers, high surface area material, binder and a carrier liquid to form a cylindrical green preform;
heating the green preform to form a rigid filter element; and
treating the rigid filter element with at least one catalyst material.

In certain embodiments, the candle filter may be obtained by a process of vacuum casting in a mould, a slurry containing high temperature resistant inorganic fibers, high surface area material with catalyst, binder and a carrier liquid to form a cylindrical green preform; and
heating the green preform to form a rigid filter element.

In certain embodiments, the candle filter may be obtained by a process of vacuum casting in a mould, a slurry containing high temperature resistant inorganic fibers, binder and a carrier liquid to form a cylindrical green preform;
contacting the green preform with high surface area material;
heating the green preform to form a rigid filter element; and
treating the rigid filter element with catalyst material.

In certain embodiments, the candle filter may be obtained by a process of vacuum casting in a mould, a slurry containing high temperature resistant inorganic fibers, binder and a carrier liquid to form a cylindrical green preform;
contacting the green preform with high surface area material and catalyst material; and
heating the green preform to form a rigid filter element.

In certain embodiments, the candle filter may be obtained by a process of vacuum casting in a mould, a slurry containing high temperature resistant inorganic fibers, high surface area material, binder and a carrier liquid to form a cylindrical green preform;
contacting the green preform with high surface area material;
heating the green preform to form a rigid filter element; and
treating the rigid filter element with catalyst material.

In certain embodiments, the candle filter may be obtained by a process of vacuum casting in a mould, a slurry containing high temperature resistant inorganic fibers, high surface area material, binder and a carrier liquid to form a cylindrical green preform;
contacting the green preform with high surface area material and catalyst material; and
heating the green preform to form a rigid filter element.

With respect to any one of the above-described embodiments, the high surface area material and/or the catalyst material may be present in the slurry containing high temperature resistant inorganic fibers, may be applied to the green preform or the rigid filter element, or combinations thereof. If the catalyst material is applied to the filter before heating or firing of the green preform, the heating or firing temperature is selected so as not to substantially deactivate the activity of the catalyst. The green preform may be dried before and/or after treatment with the high surface area material and/or catalyst material, and before heating or firing.

The addition of catalyst to the filter may occur in a separate step after the initial manufacturing process. This may include packaging and shipping filters to a different processing site or to a customer who performs the additional catalyst loading step. The addition of the catalyst material during the manufacture of the filter eliminates the additional steps needed for such off-site catalyst treatment, resulting in a more efficient manufacturing process.

The solution or suspension comprising the at least one high surface area material may be re-applied to the green preform and/or the rigid filter element and dried at least one additional time. In certain embodiments, the green preform is substantially completely soaked in the solution or suspension comprising the at least one high surface area material.

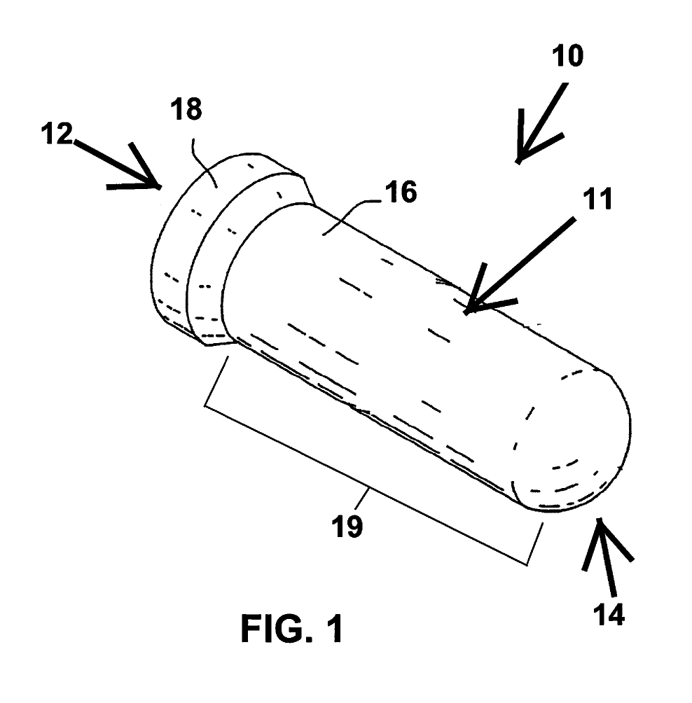

The candle filter is readily understood when read in conjunction with illustrative FIGS. 1-4. It should be noted that the filter is not limited to any of the illustrative embodiments shown in the figures, but rather should be construed in breadth and scope in accordance with the disclosure provided herein.

FIG. 1 is a perspective view of one illustrative embodiment of candle filter 10. Candle filter 10 comprises a hollow body 11 having two opposing ends, one end being a flanged open end 12 and the opposite end being a closed end 14. Candle filter 10 has inner surface (not shown) and outer surface 16. The candle filter may have a flange section 18 and a filtration section 19, wherein the thickness of the candle filter wall in the flange section 18 is greater than the thickness of the candle filter wall in the filtration section 19.

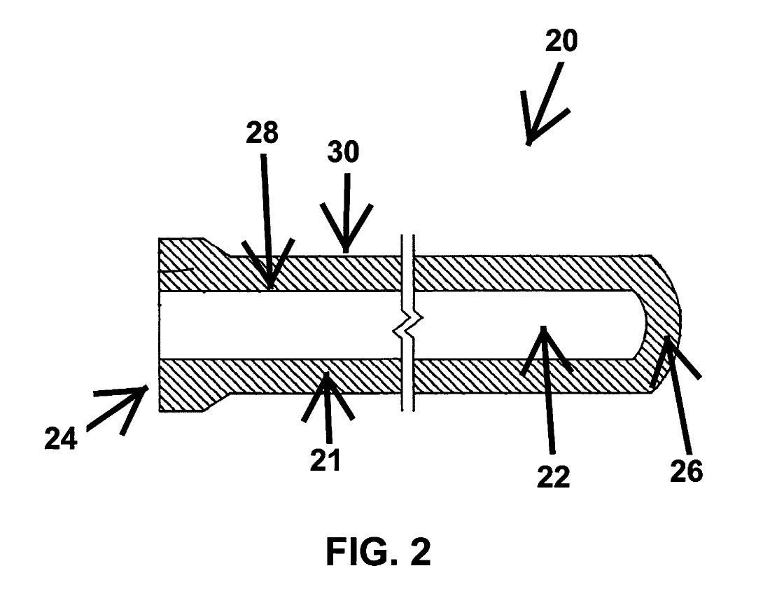

FIG. 2 is a cross-sectional view of candle filter 10 shown in FIG. 1. Candle filter 20 has hollow body 21 surrounding a cavity 22 having two opposing ends, one end being an optionally flanged open end 24 and the opposite end being a closed end 26. Candle filter 20 has inner surface 28 and outer surface 30.

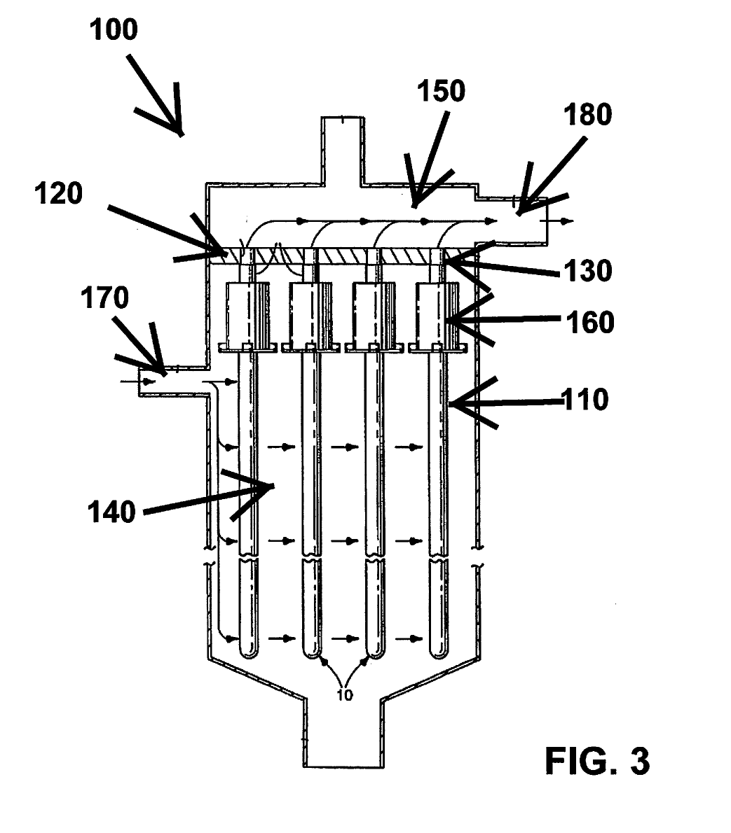

FIG. 3 is a side view, partially in cross section, of pressurized vessel 100 containing a plurality of candle filters 110 as shown in FIGS. 1 and 2. Pressurized vessel 100 comprises an air tight housing or enclosure having a tube sheet 120 that divides pressurized vessel 100 into lower compartment 140 where the particulate-laden gas enters the pressurized vessel 100, and upper compartment 150 where cleaned/filtered gas exits pressurized vessel 100. Tube sheet 120 includes a plurality of apertures 130 communicating with fixture 160 in the gasket assembly from which the candle filters 110 are mounted. Inlet port 170 enables a stream of particulate-laden hot gas to be introduced under pressure into lower compartment 140 of the pressurized vessel 100. This stream of hot gas is forced through the porous walls of candle filters 110 as herein discussed, thus filtering out the particulates on the exterior surface of candle filters 110. The clean/filtered gas emerges from the open end of candle filters 110 through the fixtures 160 into upper compartment 150, and then exits pressurized vessel 100 through outlet port 180.

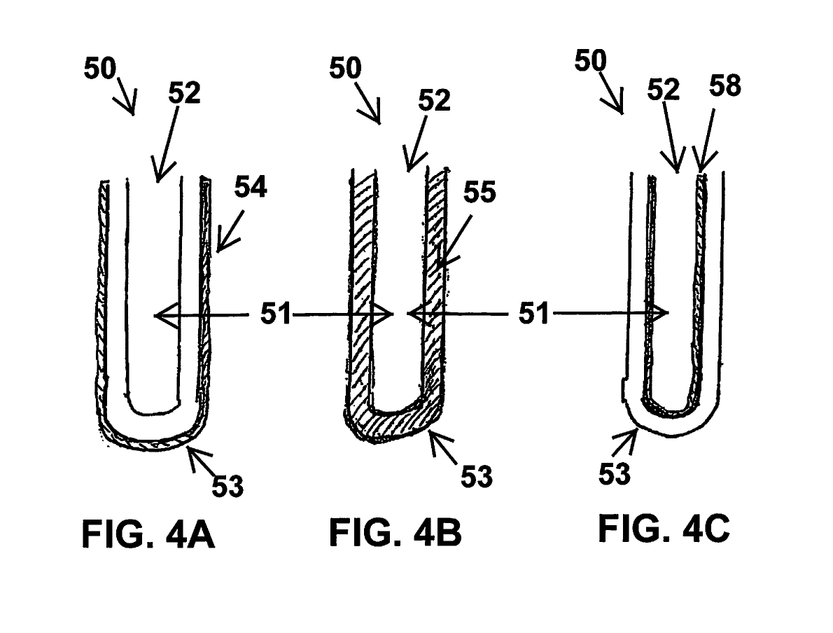

FIG. 4A is a cross-sectional view of one illustrative embodiment of candle filter 50. Candle filter 50 comprises a hollow body 51 having two opposing ends, one end being an open end 52 and the opposite end being a closed end 53. Candle filter 50 comprises a high surface area layer 54 adjacent the outer surface of filter 50.

FIG. 4B is a cross-sectional view of one illustrative embodiment of candle filter 50. Candle filter 50 comprises a hollow body 51 having two opposing ends, one end being an open end 52 and the opposite end being a closed end 53. At least one high surface area material 56 is distributed across the thickness of the filter wall 50.

FIG. 4C is a cross-sectional view of one illustrative embodiment of candle filter 50. Candle filter 50 comprises a hollow body 51 having two opposing ends, one end being an open end 52 and the opposite end being a closed end 53. Candle filter 50 comprises a high surface area layer 58 adjacent the inner surface of filter 50.

High temperature resistant inorganic fibers may be utilized in the filter that can withstand the operating temperatures of the hot gas filtration system comprising the filters. Without limitation, suitable inorganic fibers that may be used to prepare the filter include high alumina polycrystalline fibers, refractory ceramic fibers such as alumina-silicate (aluminosilicate) fibers, alumina-magnesia-silica fibers, kaolin fibers, calcium aluminate fibers, alkaline earth silicate fibers such as calcia-magnesia-silica fibers or magnesia-silica fibers, S-glass fibers, S2-glass fibers, E-glass fibers, quartz fibers, silica fibers or combinations thereof.

In certain embodiments, the final filter comprises at least about 50 weight percent inorganic fiber. In certain embodiments, the final candle filter element comprises at least about 60 weight percent inorganic fiber. In certain embodiments, the final candle filter element comprises at least about 70 weight percent inorganic fiber. In certain embodiments, the final candle filter element comprises at least about 80 weight percent inorganic fiber. In certain embodiments, the final candle filter element comprises at least about 85 weight percent inorganic fiber. In certain embodiments, the final candle filter element comprises at least about 90 weight percent inorganic fiber.

According to certain embodiments, the inorganic fibers that are used to prepare the candle filter comprise ceramic fibers. Without limitation, suitable ceramic fibers include alumina fibers, alumino-silicate fibers, alumina-boria-silicate fibers, alumina-zirconia-silicate fibers, zirconia-silicate fibers, zirconia fibers and similar fibers. A useful alumina-silicate ceramic fiber is commercially available from Unifrax I LLC (Tonawanda, N.Y.) under the registered trademark FIBERFRAX. The FIBERFRAX fibers exhibit operating temperatures of up to about 1540° C. and a melting point up to about 1870° C. The FIBERFRAX fibers can be easily formed into high temperature resistant candle filters.

The alumino-silicate fiber may comprise from about 40 weight percent to about 60 weight percent Al₂O₃ and from about 60 weight percent to about 40 weight percent SiO₂. The alumino-silicate fiber may comprise about 50 weight percent Al₂₃ and about 50 weight percent SiO₂. The alumino-silicate fiber may comprise about 30 weight percent Al₂O₃ and about 70 weight percent SiO₂. The alumino-silicate fiber may comprise from about 45 to about 51 weight percent Al₂O₃ and from about 46 to about 52 weight percent SiO₂. The alumino-silicate fiber may comprise from about 30 to about 70 weight percent Al₂O₃ and from about 30 to about 70 weight percent SiO₂. The alumino-silica-magnesia glass fiber may comprise from about 64 weight percent to about 66 weight percent SiO₂, from about 24 weight percent to about 25 weight percent Al₂O₃, and from about 9 weight percent to about 10 weight percent MgO.

The E-glass fiber typically comprises from about 52 weight percent to about 56 weight percent SiO₂, from about 16 weight percent to about 25 weight percent CaO, from about 12 weight percent to about 16 weight percent Al₂O₃, from about 5 weight percent to about 10 weight percent B₂O₃, up to about 5 weight percent MgO, up to about 2 weight percent of sodium oxide and potassium oxide and trace amounts of iron oxide and fluorides, with a typical composition of 55 weight percent SiO₂, 15 weight percent Al₂O₃, 7 weight percent B₂O₃, 3 weight percent MgO, 19 weight percent CaO and traces of the above mentioned materials.

Without limitation, suitable examples of biosoluble alkaline earth silicate fibers that can be used to prepare a candle filter include those fibers disclosed in U.S. Pat. Nos. 6,953,757, 6,030,910, 6,025,288, 5,874,375, 5,585,312, 5,332,699, 5,714,421, 7,259,118, 7,153,796, 6,861,381, 5,955,389, 5,928,075, 5,821,183, and 5,811,360, which are incorporated herein by reference.

Suitable high temperature resistant biosoluble inorganic fibers that may be used include, without limitation, alkaline earth silicate fibers, such as calcia-magnesia-silicate fibers or magnesia-silicate fibers, calcia-aluminate fibers, potassia-calcia-aluminate fibers, potassia-alumina-silicate fibers, or sodia-alumina-silicate fibers.

According to certain embodiments, the biosoluble alkaline earth silicate fibers may comprise the fiberization product of a mixture of oxides of magnesium and silica. These fibers are commonly referred to as magnesium-silicate fibers. The magnesium-silicate fibers generally comprise the fiberization product of from about 60 to about 90 weight percent silica, from greater than 0 to about 35 weight percent magnesia and 5 weight percent or less impurities. According to certain embodiments, the alkaline earth silicate fibers comprise the fiberization product of from about 65 to about 86 weight percent silica, from about 14 to about 35 weight percent magnesia and 5 weight percent or less impurities. According to certain embodiments, the alkaline earth silicate fibers comprise the fiberization product of from about 70 to about 86 weight percent silica, from about 14 to about 30 weight percent magnesia, and 5 weight percent or less impurities. A suitable magnesium-silicate fiber is commercially available from Unifrax I LLC (Tonawanda, N.Y.) under the registered trademark ISOFRAX. Commercially available ISOFRAX fibers generally comprise the fiberization product of from about 70 to about 80 weight percent silica, from about 18 to about 27 weight percent magnesia and 4 weight percent or less impurities. In certain embodiments, the fibers comprise the fiberization product of about 85 weight percent silica and 15 weight percent magnesia.

According to certain embodiments, the biosoluble alkaline earth silicate fibers may comprise the fiberization product of a mixture of oxides of calcium, magnesium and silica.

These fibers are commonly referred to as calcia-magnesia-silicate fibers. According to certain embodiments, the calcia-magnesia-silicate fibers comprise the fiberization product of from about 45 to about 90 weight percent silica, from greater than 0 to about 45 weight percent calcia, from greater than 0 to about 35 weight percent magnesia, and 10 weight percent or less impurities. According to certain embodiments, the calcia-magnesia-silicate fibers may comprise the fiberization product of greater than 71.25 to about 85 weight percent silica, greater than 0 to about 20 weight percent magnesia, about 5 to about 28.75 weight percent calcia, and 0 to about 5 weight percent zirconia.

Useful calcia-magnesia-silicate fibers are commercially available from Unifrax I LLC (Tonawanda, N.Y.) under the registered trademark INSULFRAX. In certain embodiments, the calcia-magnesia-silicate fibers comprise the fiberization product of from about 61 to about 67 weight percent silica, from about 27 to about 33 weight percent calcia, and from about 2 to about 7 weight percent magnesia. In other embodiments, the calcia-magnesia-silicate fibers comprise about 79 weight percent silica, about 18 weight percent calcia, and about 3 weight percent magnesia. Other suitable calcia-magnesia-silicate fibers are commercially available from Thermal Ceramics (Augusta, Ga.) under the trade designations SUPERWOOL 607, SUPERWOOL 607 MAX and SUPERWOOL HT. SUPERWOOL 607 fibers comprise from about 60 to about 70 weight percent silica, from about 25 to about 35 weight percent calcia, from about 4 to about 7 weight percent magnesia, and trace amounts of alumina. SUPERWOOL 607 MAX fibers comprise about 60 to about 70 weight percent silica, from about 16 to about 22 weight percent calcia, and from about 12 to about 19 weight percent magnesia, and trace amounts of alumina. SUPERWOOL HT fiber comprise about 74 weight percent silica, about 24 weight percent calcia and trace amounts of magnesia, alumina and iron oxide.

According to certain embodiments, the biosoluble alkaline earth silicate fibers may comprise the fiberization product of a mixture of oxides of calcium and aluminum. According to certain embodiments, at least 90 weight percent of the calcia-aluminate fibers comprise the fiberization product of from about 50 to about 80 weight percent calcia, from about 20 to less than 50 weight percent alumina, and 10 weight or less percent impurities. According to other embodiments, at least 90 weight percent of the calcia-aluminate fibers comprise the fiberization product of from about 50 to about 80 weight percent alumina, from about 20 to less than 50 weight percent calcia, and 10 weight percent or less impurities. According to certain embodiments, the biosoluble alkaline earth silicate fibers may comprise the fiberization product of a mixture of oxides of potassium, calcium and aluminum. According to certain embodiments, the potassia-calcia-aluminate fibers comprise the fiberization product of from about 10 to about 50 weight percent calcia, from about 50 to about 90 weight percent alumina, from greater than 0 to about 10 weight percent potassia, and 10 weight percent or less impurities.

According to certain embodiments, the biosoluble alkaline earth silicate fibers may comprise the fiberization product of a mixture of oxides of magnesium, silica, lithium and strontium. According to certain embodiments, the biosoluble alkaline earth silicate fibers comprise about 65 to about 86 weight percent silica, about 14 to about 35 weight percent magnesia, lithium oxide and strontium oxide. According to certain embodiments, the biosoluble alkaline earth silicate fibers comprise about 65 to about 86 weight percent silica, about 14 to about 35 weight percent magnesia, greater than 0 to about 1 weight percent lithium oxide and greater than 0 to about 5 weight percent strontium oxide.

According to certain embodiments, the biosoluble alkaline earth silicate fibers may comprise the fiberization product of a mixture of oxides of magnesium, silica, lithium and strontium. According to certain embodiments, the biosoluble alkaline earth silicate fibers comprise about 65 to about 86 weight percent silica, about 14 to about 35 weight percent magnesia, lithium oxide and strontium oxide. According to certain embodiments, the biosoluble alkaline earth silicate fibers comprise about 65 to about 86 weight percent silica, about 14 to about 35 weight percent magnesia, greater than 0 to about 1 weight percent lithium oxide and greater than 0 to about 5 weight percent strontium oxide. According to certain embodiments, the biosoluble alkaline earth silicate fibers comprise about 14 to about 35 weight percent magnesia, and greater than 0 to about 0.45 weight percent lithium oxide.

According to certain embodiments, the biosoluble alkaline earth silicate fibers comprise about 14 to about 35 weight percent magnesia, and greater than 0 to about 5 weight percent strontium oxide. According to certain embodiments, the biosoluble alkaline earth silicate fibers comprise about 70 or greater weight percent silica, magnesia, and greater than 0 to about 10 weight percent iron oxide.

The inorganic fibers may be shortened by chopping or cutting. The fibers may be chopped utilizing any suitable chopping or cutting method, for example, die cutting, guillotine chopping and/or waterjet cutting. The inorganic fibers may be chopped, or cut, in connection with the fiber manufacturing process when the fibers have directionality, or are laminar, rather than randomly arranged. In certain embodiments, the inorganic fibers may be melt-blown fibers, melt-spun fibers, melt-drawn fibers, and/or viscous spun fibers. The candle filter may include a blend of spun and blown inorganic fibers.

The candle filter also includes a binder or a mixture of more than one type of binder.

Suitable binders include organic binders, inorganic binders and/or combinations thereof. According to certain embodiments, the candle filter includes one or more organic binders. Examples of suitable organic binders include, but are not limited to, natural resins, synthetic resins or starch.

The candle filter may also include at least one inorganic binder material, in addition to, or as an alternative to, organic binder. The inorganic binder may be any of those known for their suitability for bonding ceramic fibers. Without limitation, suitable inorganic binder materials include a colloidal dispersion, such as colloidal silica, alumina, zirconia, titania, zinc, magnesia or combinations thereof. In certain embodiments, the at least one inorganic binder is ammonia-stabilized. In certain embodiments, the at least one inorganic binder comprise an ammonia-stabilized colloidal silica dispersion.

The inorganic binder may comprise clay. The clay may be calcined or uncalcined, and may include but not be limited to attapulgite, ball clay, bentonite, hectorite, kaolininte, kyanite, montmorillonite, palygorskite, saponite, sepiolite, sillimanite, or combinations thereof.

The candle filter may include at least one catalyst material. Various combinations of catalysts can be applied at and/or near the surface of the filter and/or distributed across the thickness profile of the filter wall. Without limitation, suitable catalysts include titanium dioxide, vanadium pentoxide, tungsten trioxide, aluminum trioxide, manganese dioxide, zeolites, and transition metals and their oxides.

The catalyst material can provide multiple functionality, that is, it can promote two or more reactions, optionally simultaneously. Alternatively, a combination of catalyst material can be used to achieve multiple functionality.

The catalyst is applied to the high surface area material of the filter. During operation of the filter, as gas passes through the portion of the filter containing the high surface area material to which the catalyst material is bonded, contaminants within the gas will react with the active sites on the catalyst to convert the contaminants to a more desirable by-product, for example reducing nitrogen oxides to nitrogen and water/vapor. The operating conditions for the catalyzed filter is in the range of about 200° to about 600° Celsius for NOₓ catalysis.

The candle filter may include at least one high surface area material distributed throughout the thickness of the candle filter wall, or in a layer adjacent to the inner and/or outer surfaces of the candle filter, or both. By way of illustration, not limitation, suitable examples of the at least one high surface area material include microfine glass fibers, microfibers, microporous fibers, catalyst grade fibers, zeolites, carbon nanotubes and other nanomaterials and nanoparticles.

Without limitation, suitable microfine glass fibers include Laucha glass microfibers which are commercially available from Unifrax I LLC (Tonawanda, N.Y.). These high tensile strength fibers have an average diameter from 0.25 to 5.0 microns, have a high specific surface area (SSA) between 0.5 and 5 m²/g, a long length to diameter ratio (L:D) and may consist of multiple glass chemistries such as A, B, C and E-glass.

Without limitation, suitable catalyst grade fibers include Saffil CG fibers which are commercially available from Unifrax I LLC (Tonawanda, N.Y.). These microporous high purity alumina fibers exhibit extremely high surface area. The homogenous distribution of porosity, the presence of small alumina crystallites, and the uniformity of fiber diameter result in a porous fiber with high specific surface area between 150 to 200 m²/g.

In certain embodiments, the candle filter comprises aluminosilicate fibers, colloidal silica, optionally a catalyst material, and further optionally at least one high surface area material.

In certain embodiments, a slurry of components is wet laid onto a pervious cylindrical/tube shaped mould. A vacuum is applied to the open end of the mould to extract the majority of the moisture from the slurry, thereby forming a wet cylindrical “green” tube, i.e., before the binder has set. The green tube is then dried to form a preform structure. The preform is then heated, resulting in a rigid filter element.

After the preform is dried, it may be cooled to room temperature and contacted, dipped or otherwise soaked at least once in a solution or suspension comprising at least one high surface area material and optionally at least one catalyst material. In certain embodiments, the preform is submerged into the solution or suspension comprising the least one high surface area material and optionally at least one catalyst material. In certain embodiments, the preform is completely impregnated with the least one high surface area material, optionally to the point of saturation. In other embodiments, the preform is partially impregnated with the at least one high surface area material to form an enhanced surface area layer on the inner and/or outer surface of the filter.

In certain embodiments, the solution or suspension comprising the at least one high surface area material is spread, brushed, sprayed, coated or otherwise applied to the green preform.

The solution or suspension comprising the at least one high surface area material may be applied to the green preform and/or rigid filter element multiple times before and/or after being subjected to the drying step.

While the catalytic filter, and methods of preparing the catalytic filter have been described in connection with various embodiments, it is to be understood that other similar embodiments may be used or modifications and additions may be made to the described embodiments for performing the same function. It will be understood that the embodiments described herein are merely illustrative, and that one skilled in the art may make variations and modifications without departing from the spirit and scope of the invention. Further, all embodiments disclosed are not necessarily in the alternative, as various embodiments may be combined to provide the desired result.

1. A filter element comprising high temperature resistant inorganic fibers, at least one binder and at least one high surface area catalyst support material.

2. The filter element of claim 1, wherein at least one catalyst material is bonded to, absorbed by or absorbed onto the surface of the at least one high surface area catalyst support material.

3. The filter element of claim 1, wherein the at least one high surface area catalyst support material is distributed across the thickness of the filter element.

4. The filter element of claim 1, wherein the at least one high surface area catalyst support material is substantially uniformly distributed across the thickness of the filter element.

5. The filter element of claim 1, wherein the at least one high surface area catalyst support material is adjacent to a surface of the filter element to form an enhanced surface area layer.

6. The filter element of claim 5, wherein the enhanced surface area layer is an integrated layer having a gradient composition across at least a portion of the thickness of the filter element.

7. The filter element of claim 5, comprising a hollow cylindrical tube having a wall with an inner surface and an outer surface.

8. The filter element of claim 7, wherein the at least one high surface area catalyst support material is present in a layer adjacent to the inner and/or outer surface of the filter element to form an enhanced surface area layer.

9. The filter element of claim 8, wherein the at least one high surface area catalyst support material is present in a layer adjacent to the outer surface of the filter element to form the enhanced surface area layer.

10. The filter element of claim 8, wherein the at least one high surface area material is present in a layer adjacent to the inner surface of the filter element to form the enhanced surface area layer.

11. The filter element of claim 1, wherein the high temperature resistant inorganic fibers comprise at least one of high alumina polycrystalline fibers, refractory ceramic fibers, alumina-silicate fibers, alumina-magnesia-silicate fibers, kaolin fibers, calcium aluminate fibers, alkaline earth silicate fibers, calcia-magnesia-silicate fibers, magnesia-silicate fibers, S-glass fibers, S2-glass fibers, E-glass fibers, quartz fibers, silica fibers or combinations thereof.

12. The filter element of claim 11, wherein the refractory ceramic fibers comprise alumino-silicate fibers comprising the fiberization product of from about 30 to about 70 weight percent alumina and from about 30 to about 70 weight percent silica.

13. The filter element of claim 11, wherein the biosoluble fibers comprise magnesia-silicate fibers comprising the fiberization product of from about 60 to about 90 weight percent silica, from greater than 0 to about 35 weight percent magnesia and 5 weight percent or less impurities.

14. The filter element of claim 11, wherein the biosoluble fibers comprise calcia-magnesia-silicate fibers comprising the fiberization product of from about 45 to about 90 weight percent silica, from greater than 0 to about 45 weight percent calcia, and from greater than 0 to about 35 weight percent magnesia.

15. The filter element of claim 1, wherein the at least one binder comprises an inorganic binder.

16. The filter element of claim 15, wherein the inorganic binder comprises a colloidal metal oxide dispersion selected from the group consisting of silica, alumina, titania, zinc, magnesia, zirconia, or combinations thereof.

17. The filter element of claim 1, wherein the high surface area material comprises at least one of microfine glass fibers, microfibers, microporous fibers, catalyst grade fibers, zeolites, carbon nanotubes, nano materials or combinations thereof.

18. The filter element of claim 17, wherein the high surface area material comprises microfine glass fibers.

19. The filter element of claim 17, wherein the high surface area material comprises microporous fibers.

20. The filter element of claim 17, wherein the high surface area material comprises catalyst grade fibers.

21. The filter element of claim 1, wherein the at least one catalyst material comprises at least one of titanium dioxide, vanadium pentoxide, tungsten trioxide, aluminum trioxide, manganese dioxide, zeolites, transition metals and their oxides or combinations thereof.
